(19) United States
(12) Patent Application Publication
(10) Pub. No.: US 2017/0331904 A1
(43) Pub. Date: Nov. 16, 2017

(54) MAINTENANCE OF FEATURE SETTINGS ACROSS MULTIPLE USER SYSTEMS ON A COMMUNICATION

(71) Applicant: Avaya Inc., Basking Ridge, NJ (US)

(72) Inventors: Anand Padhye, Pune (IN); Sanjog Narayan Kotnis, Pune (IN)

(21) Appl. No.: 15/152,751

(22) Filed: May 12, 2016

(51) Int. Cl. H04L 29/08

(52) U.S. Cl. CPC H04L 67/148; H04L 67/34

(57) ABSTRACT

Embodiments disclosed herein provide systems, methods, and computer readable media for maintaining feature settings across user systems. In a particular embodiment, a method provides, in a first user system having a first feature set, exchanging communications for a communication session using first settings of features in the first feature set. The method further provides determining a current state of the first settings before a second user system having a second feature set joins the communication session and configuring second settings of the second feature set that correspond to the first settings in accordance with the current state. In the second user system, the method provides exchanging communications for the communication session using the second settings of the second feature set.

### TECHNICAL FIELD

Aspects of the disclosure are related to system settings during user communications and, in particular, to transferring communications of a user from one device to another.

### TECHNICAL BACKGROUND

Communication systems allow users to communicate using a wide range of systems and devices. For example, a user may be able to make a call or participate in a video conference from a computer, mobile phone, or some other type of computing system. Additionally, these communication systems may allow for a user to transfer communications between devices. For instance, a user may begin a communication one a stationary device and switch the communication over to a mobile device so that the user can move without leaving the communication. Unfortunately, when the communication is moved to the other device, any settings that were in effect on the static device will not be in effect on the mobile device (e.g. the microphone on the mobile device will not be muted as it was on the static device).

### OVERVIEW

Embodiments disclosed herein provide systems, methods, and computer readable media for maintaining feature settings across user systems. In a particular embodiment, a method provides, in a first user system having a first feature set, exchanging communications for a communication session using first settings of features in the first feature set. The method further provides determining a current state of the first settings before a second user system having a second feature set joins the communication session and configuring second settings of the second feature set that correspond to the first settings in accordance with the current state. In the second user system, the method provides exchanging communications for the communication session using the second settings of the second feature set.

In some embodiments, the method provides receiving first user input from a first user of the first user system indicating that the communication session should be extended to the second user system and transferring the communication session from the first user system to the second user system in response to the first user input.

In some embodiments, the method provides determining the current state and configuring the second settings in response to the first user input.

In some embodiments, configuring the second settings comprises, when one or more of the second settings do not have a corresponding setting in the first settings, configuring the one or more of the second settings in accordance with one or more default settings.

In some embodiments, the method provides presenting a first user of the first user system with an option to configure the second settings in accordance with the current state of the first settings.

In some embodiments, receiving first user input from the first user indicating selection of the option and configuring the second settings in response to the first user input.

In some embodiments, the method provides presenting the first user with an option to modify the current state of the first settings before configuring the second settings.

In some embodiments, the method provides receiving first user input from the first user indicating one or more modifications to the current state of the first settings and further configuring the second settings in accordance with the one or more modifications.

In some embodiments, a current state of an audio mute setting within the first settings indicates that audio captured by the first user system is muted in the communication session and the method further provides configuring the second settings comprises configuring an audio mute setting within the second settings to mute audio captured by the second user system in the communication session.

In some embodiments, a current state of a video mute setting within the first settings indicates that video captured by the first user system is muted in the communication session and the method further provides configuring the second settings comprises configuring a video mute setting within the second settings to mute video captured by the second user system in the communication session.

In another embodiment, a communication control system is provided that includes one or more computer readable storage media, a processing system operatively coupled with the one or more computer readable storage media, and program instructions stored on the one or more computer readable storage media. The program instructions, when read and executed by the processing system, direct the processing system to facilitate a communication exchange by a first user system having a first feature set for a communication session using first settings of features in the first feature set. The program instructions further direct the processing system to determine a current state of the first settings before a second user system having a second feature set joins the communication session and configure second settings of the second feature set that correspond to the first settings in accordance with the current state. Also, the program instructions direct the processing system to facilitate a communication exchange by the second user system for the communication session using the second settings of the second feature set.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a communication environment for maintaining feature settings across user systems.

FIG. 2 illustrates a method of operating in the communication environment to maintain feature settings across user systems.

FIG. 3 illustrates another communication environment for maintaining feature settings across user systems.

FIG. 4 illustrates an operational scenario of the other communication environment to maintain feature settings across user systems.

FIG. 5 illustrates an operational scenario of the other communication environment to maintain feature settings across user systems.

FIG. 6 illustrates an operational scenario of the other communication environment to maintain feature settings across user systems.

FIG. 7 illustrates an application window in an example scenario of maintaining feature settings across user systems.

FIG. 8 illustrates an application window in an example scenario of maintaining feature settings across user systems.

FIG. 9 illustrates an application window in an example scenario of maintaining feature settings across user systems.

FIG. 10 illustrates a computing architecture for implementing a communication control system to maintain feature settings across user systems.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

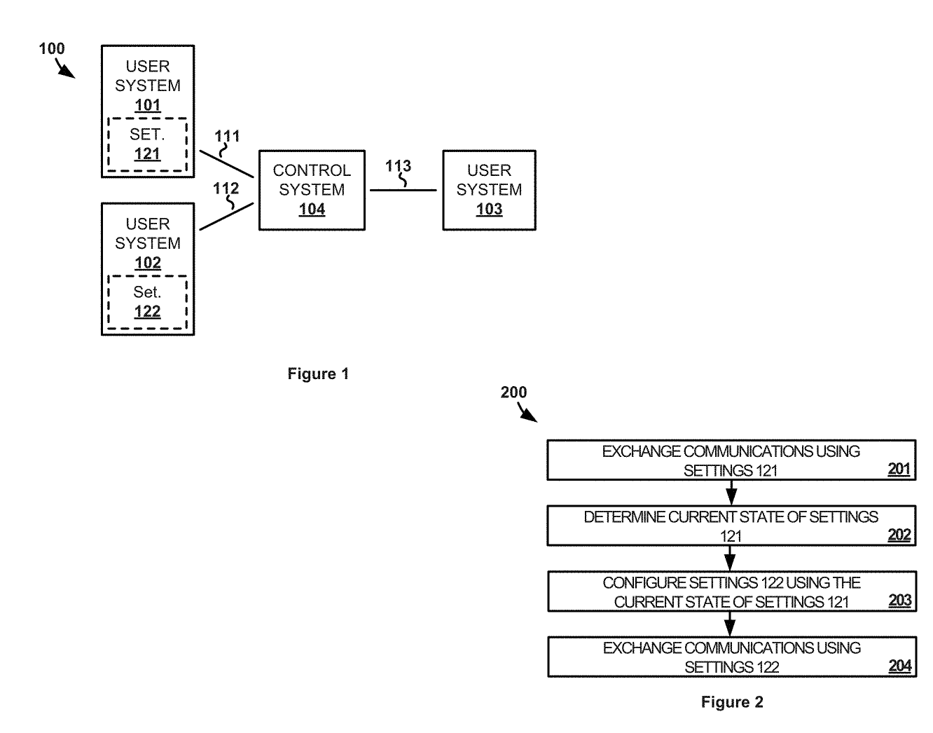

FIG. 1 illustrates communication environment 100 for maintaining feature settings across user systems. Communication environment 100 includes user system 101, user system 102, user system 103, and communication control system 104. User system 101 and communication control system 104 communicate over communication link 111. User system 102 and communication control system 104 communicate over communication link 112. Communication control system 104 and user system 103 communicate over communication link 113.

In operation, user system 101 and user system 103 are exchanging real-time communications for their respective users. The communications may be voice communications or may include other types of media, such as video. The communications may pass through communication control system 104, some other communication system(s), or be exchanged directly between user system 101 and user system 103—including combinations thereof. When a user of user system 101 decides to transfer the communications from user system 101 to user system 102, communication control system 104 is configured to handle the transfer. Handling the transfer may include instructing user system 103 to direct communications to user system 103 instead of user system 101, communication control system 104 redirecting the communications from user system 103 itself if the communications pass through communication control system 104, instruct user system 102 to being exchanging communications with user system 103, or perform any other function that may be necessary to move communications from user system 101 to user system 102. After the transfer, user system 102 allows its user to continue the real-time communication with the user(s) of user system 103.

Additionally, many types of communications, such as conference calls, allow a user to select various options while on the call. These options may include muting the microphone of a user system, blocking video captured by the user system, turning off video received from other user systems, or any other type of setting that may effect how a communication is handled at a user system. The options may vary between user systems due to a feature set of the user system itself or due to a mode in which a communication is connected to the real-time communication (e.g. via phone call which allows only voice or through an application that allows video). In the example from above, not only does communication control system 104 transfer the communication from user system 101 to user system 102, communication control system 104 also configures user system 102 such that settings 122 are consistent with settings 121 from user system 101, as described in more detail below. For instance, if a microphone of user system 101 is muted according to settings 121, settings 122 may be configured to mute a microphone of user system 102 when the communication is transferred to user system 102. The user therefore does not need to worry that something inadvertent will be heard when the communication is transferred to user system 102 and before the user would have been able to manually mute the microphone of user system 102.

FIG. 2 illustrates method 200 of operating in communication environment 100 to maintain feature settings across user systems. In user system 101 having a first feature set, method 200 provides exchanging communications for a communication session using settings 121 of features in the first feature set (201). The first feature set may include one or more microphones for audio capture, one or more cameras for capturing photos or video, one or more displays for displaying video or other graphical information, one or more speakers for presenting sounds, or some other type of feature that may be useful on a communication—including combinations thereof. The communication session itself may be audio only, video, or include some other type of media, such as presentation slides. The communication session may be between user system 101 and user system 103 or may include one or more additional user systems, as may be the case on a conference call.

Before user system 102 joins the communication session, method 200 provides communication control system 104 determining a current state of the first settings (202). Communication control system 104 may continually be updated with the current state of settings 121 during the communication session or may only be notified of the state of settings 121 upon receiving an indication that user system 102 is to join the communication session. In either situation, user system 101 may transfer the current state of settings 121 to communication control system 104 automatically or communication control system 104 may request the current state of settings 121 from user system 101. Settings 121 may represent what features of user system 101 are enabled on the communication session and/or how those features are configured on the communication session. Settings 121 may include whether a microphone is muted, a speak audio volume level, whether a camera of user system 101 should be used to transfer video from user system 101, whether user system 101 should receive video from other systems on the communication session, or any other type of setting that may effect a feature of a user system as it may be used in a communication session—including combinations thereof.

Method 200 then provides communication control system 104 configuring settings 122 of user system 102's feature set that correspond to settings 121 in accordance with the current state of settings 121 (203). In some cases, if settings 121 and settings 122 are identical, then communication control system 104 can simply replicate settings 121 into settings 122. However, since user system 101 and user system 102 may not be identical systems, communication control system 104 may perform a translation to configure settings 122 into a state that corresponds to the current state of settings 121. For example, user system 101 and user system 102 may be some combination of a smartphone, computer workstation, tablet, laptop, set-top box, or some other type of computing system. As such, user system 101 and user system 102 may also have different feature sets and, therefore, certain settings that exist in settings 121 may not have a corresponding setting in settings 122 and vice versa. In those cases, communication control system 104 may configure only those settings of settings 122 that correspond to settings in settings 121 and leave the remaining settings of settings 122 untouched or use default states for those remaining settings. Once the state of settings 122 is determined from settings 121, to configure settings 122 communication control system 104 may transfer settings 122 in a message to user system 102 or may otherwise instruct user system 102 to itself change settings 122 into the configuration determined by communication control system 104.

Method 200 then provides user system 102 exchanging communications for the communication session using settings 122 (204). As such, user system 102 joins the communication session with settings 122 already being configured substantially the same as settings 122. Communication control system 104 may remove user system 101 from the communication when user system 102 joins or user system 101 may remain on the communication, as may be the case if a user is still present at user system 101 while one or more other users begin using user system 102.

Additionally, some communication modes allow multiple user systems to be assigned the same extension or equivalent identifier. For instance, user systems 101 and 102 may both be desk phones of the same type or of different types. Regardless, both user systems may use the same extension for communicating. In these cases, the user of user system 101 could be on a communication using user system 101 and can simply pick up (or otherwise activate) on user system 102 in order to join the communication from user system 102. By virtue of having the same extension, user system 102 would automatically join the communication and, in accordance with method 200, would have settings configured based on user system 101's settings.

Referring back to FIG. 1, user systems 101, 102 and 103 each comprise a computer processor system and a communication interface. User systems 101, 102 and 103 may also include other components such as a microphone, camera, display, a router, server, data storage system, and power supply. User systems 101, 102 and 103 may each reside in a single device or may be distributed across multiple devices. User systems 101, 102 and 103 may be a telephone, computer, tablet, conference room system, e-book, mobile Internet appliance, network interface card, media player, game console, or some other communication apparatus—including combinations thereof.

Communication control system 104 comprises a computer processor system and communication interface. Communication control system 104 may also include other components such as a router, server, data storage system, and power supply. Communication control system 104 may reside in a single device or may be distributed across multiple devices. While shown separately, communication control system 104 may be incorporated into one or more of user systems 101, 102 and 103. Communication control system 104 may be an audio communication server, video communication server, application server, conference bridge, personal computer workstation, network gateway system, or some other computing system—including combinations thereof.

Communication links 111-113 use metal, glass, air, space, or some other material as the transport media. Communication links 111-113 could use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format—including combinations thereof. Communication links 111-113 could be direct links or may include intermediate networks, systems, or devices.

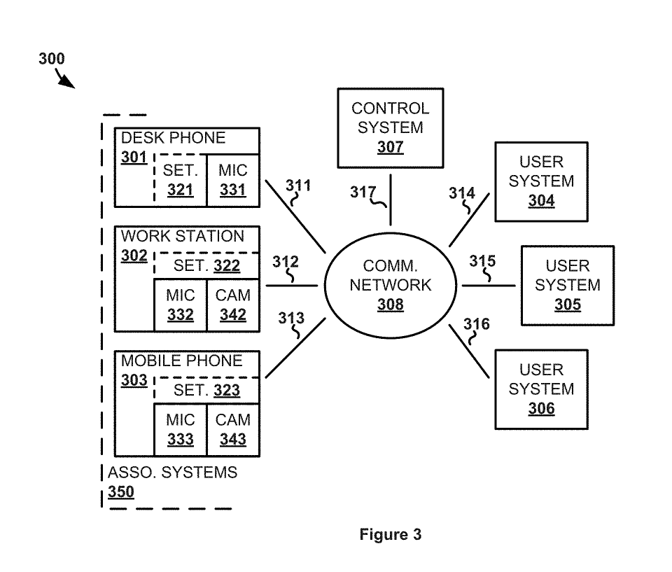

FIG. 3 illustrates communication environment 300 for maintaining feature settings across user systems. Communication environment 300 includes desk phone 301, workstation 302, mobile phone 303, user systems 304-306, communication control system 307, and communication network 308. Desk phone 301, workstation 302, and mobile phone 303, are collectively considered associated systems 350. Elements 301-307 and communication network 308 communicate over communication links 311-317, respectively.

Communication network 308 comprises network elements that provide communications services to elements 301-307. Communication network 308 may comprise switches, wireless access nodes, Internet routers, network gateways, application servers, computer systems, communication links, or some other type of communication equipment—including combinations thereof. Communication network 308 may be a single network, such as a local area network, a wide area network, or the Internet, or may be a combination of multiple networks.

In operation, communication control system 307 also acts as a videoconferencing bridge between user systems of parties on a videoconference. Communication environment 300 specifically shows a videoconference between one of associated systems 350, user system 304, user system 305, and user system 306. In this example, associated systems 350 are all under the control of a single user (e.g. owned by, assigned to, or otherwise within the control of that user), although other examples may allow for the associated devices to be controlled by other parties. Associated systems 350 may each be registered with communication control system 307 by the user or some other individual. For instance, the user may have an account with communication control system 307 and may indicate that desk phone 301, workstation 302, and mobile phone 303 are all systems that may be used under the account. In this way, when one of associated systems 350 is on a videoconference, communication control system 307 and that associated system can already be aware of the possible other associated systems to which the videoconference may be transferred. Alternatively, one or more of associated systems 350 may be identified at some other time, including at the time the videoconference is to be transferred.

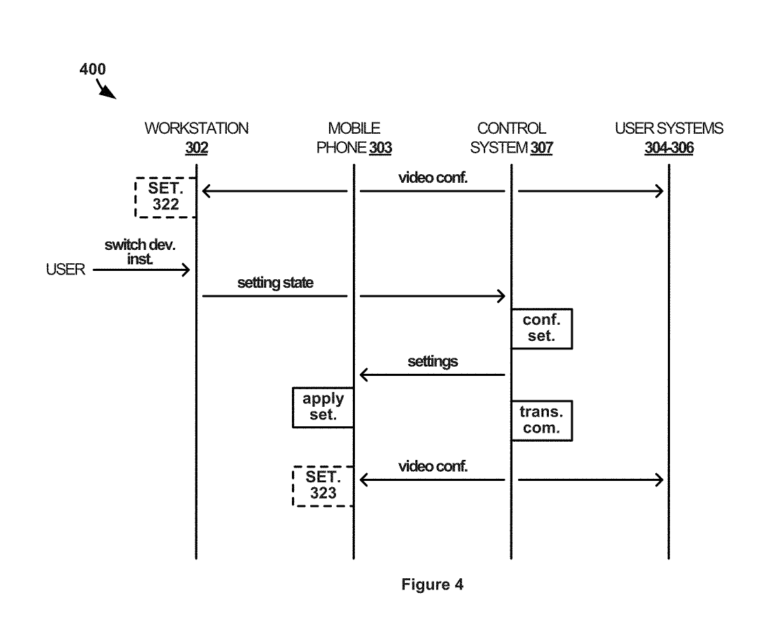

FIG. 4 illustrates operational scenario 400 of communication environment 300 to maintain feature settings across user systems. In operational scenario 400, workstation 302 is connected to a video conference with user system 304, user system user system 305, and user system 306 so that users at each of the systems can participate as parties on the videoconference. Depending on the configuration, user communications for the videoconference may pass through communication control system 307 or may be directly exchanged between participant systems. Workstation 302, user system 304, user system 305, and user system 306 may all execute software, such as a videoconferencing application, that directs the respective systems to exchange communications at the direction of communication control system 307. Although, communication control system 307 may also be able to bridge between different communication modes. For instance, user system 305 may be a PSTN type telephone, which doesn't have video capability, and communication control system 307 may be able to bridge user system 305's PSTN call to the videoconference such that the user(s) at user system 305 can still participate in the audio of videoconference.

During the videoconference, workstation 302 uses settings 322 for a feature set of workstation 302. In this example, the features set of workstation 302 includes microphone 332 and camera 342, although other not illustrated features, such as video display, may also be subject to settings 322. Settings 322 may, for instance, indicate whether audio captured by microphone 332 should be presented on the videoconference or should be muted. Similarly, settings 322 may indicate whether video captured by camera 342 should be transferred on the videoconference or should be “muted” in that no video is presented on the video conference. Settings 322 may be changed by the user of workstation 302 at any time during the videoconference. For example, the user may change the state of settings 322 to unmute microphone 332 whenever the user wishes to speak and muting microphone 332 to prevent unnecessary background noise on the videoconference when not speaking.

At some point during the videoconference, the user of workstation 302 determines that they want to switch their end of the videoconference to mobile phone 303 and provides input into workstation 302 instructing that switch to occur. The user may want to switch to mobile phone 303 so that they can move from their desk where workstation 302 is located, although the user's reason for switching devices is not necessarily relevant to scenario 400. In response to the user's instruction, workstation 302 transfers the current state of settings 322 to communication control system 307. The transfer of the current state may be performed automatically by workstation 302, and may represent, include, or otherwise be transferred in addition to a notification message to communication control system 307 indicating that the videoconference should be moved from workstation 302 to mobile phone 303. Alternatively, the current state may be transferred in response to a request for the current state from communication control system 307, which may be transferred by communication control system 307 in response to a notification message from workstation 302 indicating that the videoconference should be moved from workstation 302 to mobile phone 303. In some cases, workstation 302 may transfer the current state of settings 322 whenever the state changes. In those cases, the current state of settings 322 may already be known to communication control system 307 at the time the instruction to transfer the videoconference is received.

In alternative examples, the user instruction may be provided as user input into the system to which the videoconference will be switched. For instance, rather than providing input into workstation 302, the user may provide input into mobile phone 303 indicating that mobile phone 303 should replace workstation 302 on the videoconference. In particular, a user interface element of mobile phone 303 (e.g. within a videoconference application executing on mobile phone 303) may accept user input to direct communication control system 307 to transfer the videoconference from workstation 302 to mobile phone 303.

Once communication control system 307 has received the current state of settings 322 from workstation 302, communication control system 307 configures the state of settings 323 of mobile phone 303 to correspond to the current state of settings 322. In this case, the feature set of workstation 302 substantially matches the feature set of workstation 302 in that mobile phone 303 has microphone 333 and camera 343. Thus, communication control system 307 will configure the state of settings 323 with respect to microphone 333 and camera 343 to reflect the state of settings 322 with respect to microphone 332 and camera 342. For instance, if both of microphone 332 and camera 342 are muted, then both of microphone 333 and camera 343 will also be muted in accordance with settings 323.

The state of settings 323 after configuration is transferred to mobile phone 303 where they are applied before mobile phone 303 joins the videoconference. Once the state of settings 323 has been transferred, or contemporaneously with the state of settings 323 being transferred, communication control system 307 performs any actions necessary to transfer videoconference communications of workstation 302 to mobile phone 303. Those actions, once completed, result in the same videoconference as before only now mobile phone 303 is on the conference with user system 304, user system 305, and user system 306, rather than workstation 302. Initially, mobile phone 303 is on the videoconference using the state of settings 323 as received from communication control system 307. However, the user of mobile phone 303 can change settings 323 at will going forward on the videoconference. For instance, if settings 323 initially has camera 343 not muted, the user may decide to mute camera 343 so that video from camera 343 is no longer included on the videoconference.

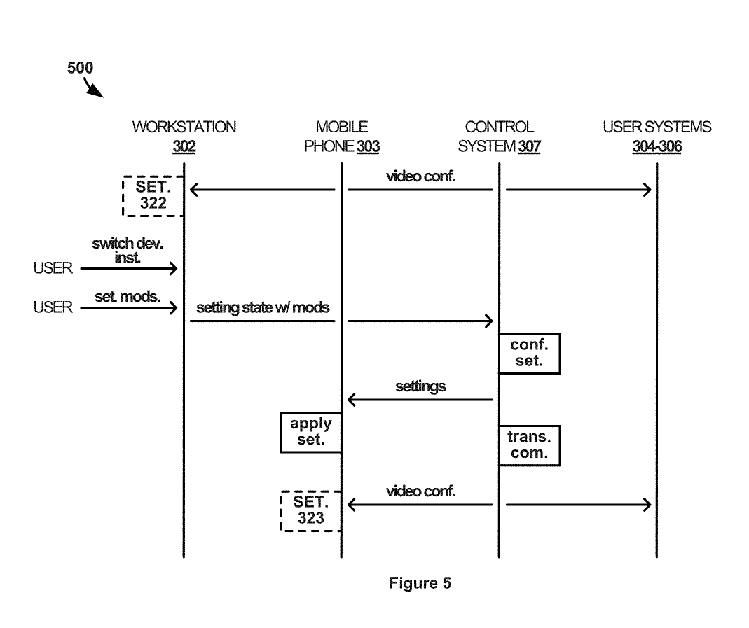

FIG. 5 illustrates operational scenario 500 of communication environment 300 to maintain feature settings across user systems. Scenario 500 begins in much the same way as scenario 400 with a videoconference between workstation 302, user system 304, user system 305, and user system 306. Also like scenario 400, workstation 302 is using settings 322 during the videoconference for microphone 332 and camera 342. Scenario 500 likewise receives a user instruction indicating that the user wishes for the videoconference to be transferred from workstation 302 to mobile phone 303. However, in scenario 500, workstation 302 presents the user with one or more options to modify the state of settings 322 before transferring them to communication control system 307. For instance, the current state of settings 322 may indicate that camera 342 is currently unmuted and workstation 302 provides the user with the option to mute camera 343 when the videoconference is transferred to mobile phone 303. In some cases, the modification that the user makes to the settings may be applied to settings 322 for the time, if any, that workstation 302 remains on the conference.

The modified state of settings 322 is then transferred to communication control system 307, which configures settings 323 to correspond to the modified settings. For instance, continuing the example above, settings 323 are configured such that camera 343 is muted when mobile phone 303 joins on the videoconference. Mobile phone 303 applies settings 323 from communication control system 307 and communication control system 307 transfers the videoconference to mobile phone 303 in the same manner as in scenario 400.

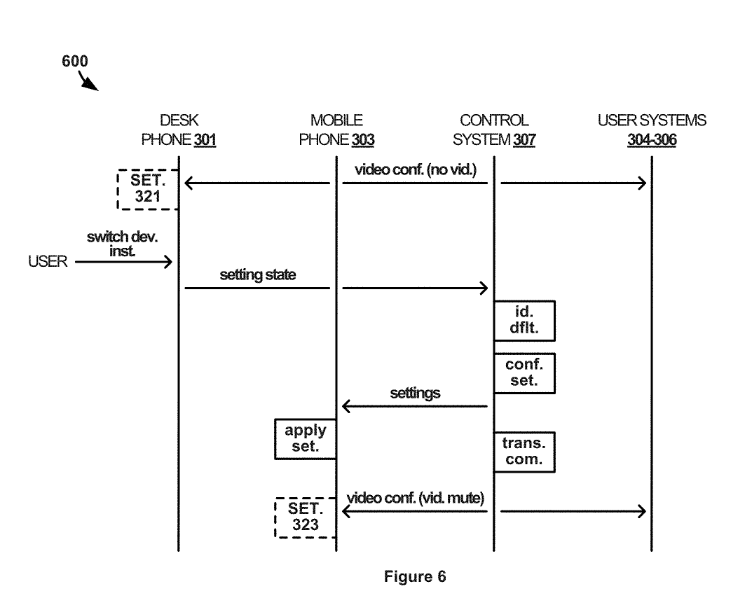

FIG. 6 illustrates operational scenario 600 of communication environment 300 to maintain feature settings across user systems. Scenario 600 begins with the videoconference between desk phone 301, user system 304, user system 305, and user system 306. In the case of desk phone 301, the feature set is less than that of workstation 302 and mobile phone 303. Specifically, desk phone 301 does not include a camera and settings 321 therefore do not apply to a camera. Thus, at least for the purposes of this example, desk phone 301 is participating in the videoconference in an audio only capacity.

Since desk phone 301 does not include a camera, when the user instructs the videoconference to switch from desk phone 301 to mobile phone 303, no current state of a camera is included in the current state of settings 321 when sent to communication control system 307. As such, the setting state for camera 343 in settings 323 does not have a corresponding setting in settings 321. Communication control system 307 therefore determines a default setting state for camera 343 in settings 323 and configures the state of settings 323 in accordance with that default. For example, the default setting may be to mute camera 343 so that no unwanted video is viewed on the videoconference when the conference is initially transferred to mobile phone 303. While a default setting is needed only for camera 343 in this example, other examples may require default settings for other or additional features that are not included in the state of settings 321.

Once the default is determined, settings 323 are configured by communication control system 307 and transferred to mobile phone 303 so that mobile phone 303 can apply them on the videoconference. Communication control system 307 likewise transfers the videoconference communications to mobile phone 303 and mobile phone 303 continues on the videoconference with user system 304, user system 305, and user system 306 using settings 323.

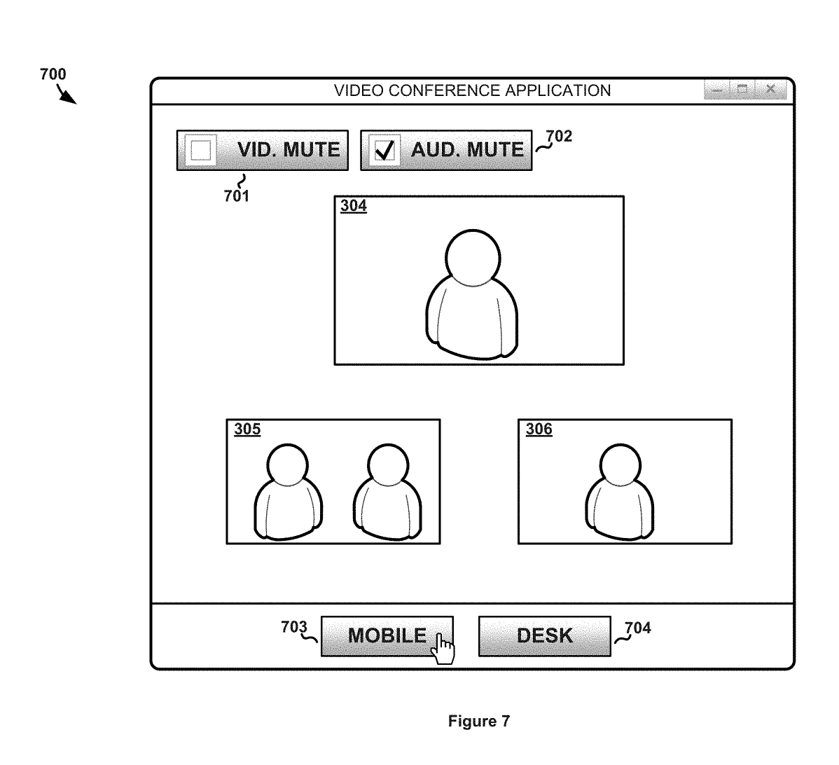

FIG. 7 illustrates application window 700 in an example scenario of maintaining feature settings across user systems. In this example, application window 700 is a window of a videoconferencing application that is displayed by workstation 302. Application window 700 displays three video streams, one from each of user systems 304-306, showing four other participants on the videoconference. Application window 700 further displays two setting options, video mute setting 701 and audio mute setting 702. When selected, video mute setting 701 stops video captured by workstation 302 from being presented on the videoconference and audio mute setting 702 stops audio captured by workstation 302 from being presented on the videoconference. In this instance, only audio mute setting 702 is selected.

Application window 700 also displays two options for the user to transfer the videoconference to other devices so that the user can continue the videoconference on that device. Specifically, selection of mobile option 703 will transfer the videoconference to mobile phone 303 and selection of desk option 704 will transfer the videoconference to desk phone 301. In this example, the user selects mobile option 703 to transfer the videoconference to mobile phone 303.

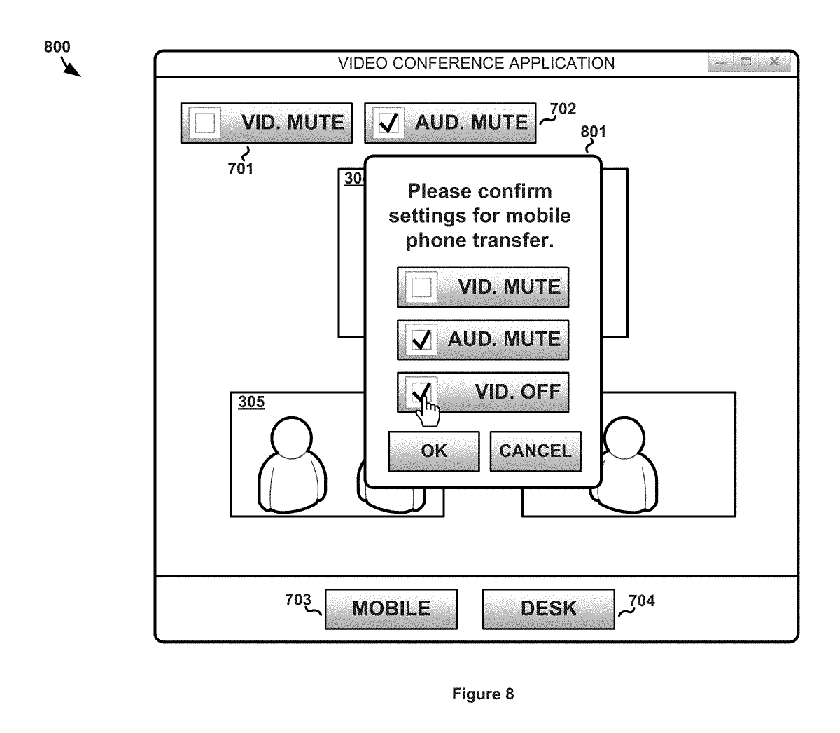

FIG. 8 illustrates application window 800 in an example scenario of maintaining feature settings across user systems. Application window 800 is an example of application window 700 after the user selects mobile option 703. Application window 800 displays an example option menu 801 that asks the user to confirm the settings from workstation 302 that the user wishes be transferred along with the videoconference communications to mobile phone 303. In particular, audio mute 702 is currently enabled on workstation 302. Therefore, when option menu 801 is initially displayed, only audio mute is enabled for transfer to mobile phone 303. However, the user also has the option to turn on video mute or video off. Enabling video mute prevents video captured by camera 342 of workstation 302 from being presented on the video conference while video off disables all video, effectively making mobile phone 303 an audio only device on the videoconference. In this example, the user selects the video off settings in addition to the audio mute setting already selected. Upon pressing “OK,” those settings are transferred by workstation 302 to communication control system 307 so that mobile phone 303 can be configured with the settings when videoconference communications are transferred.

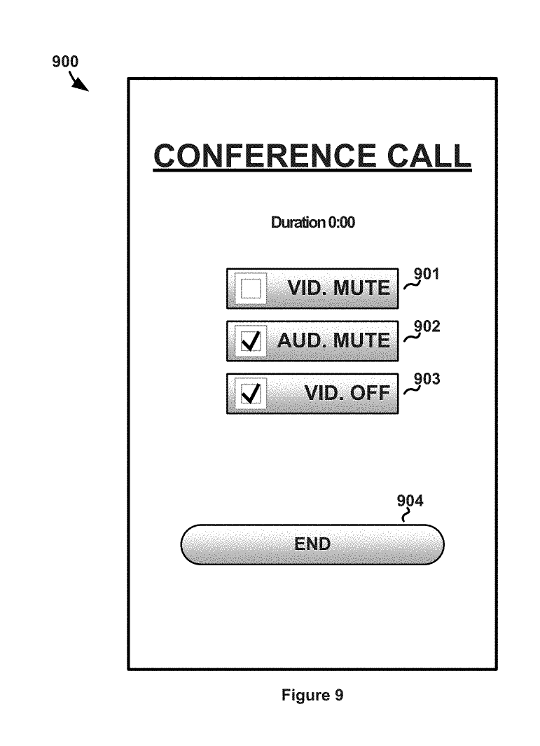

FIG. 9 illustrates application window 900 in an example scenario of maintaining feature settings across user systems. Application window 900 is an example of what would be displayed in a videoconferencing application executing on mobile phone 303 after communication control system 307 transfers videoconference communications to mobile phone 303. Application window 900 includes video mute option 901, audio mute option 902, and video off option 903, which are configured as the user directed into application window 800 above. Application window 900 also provides the user with end call option 904. In some cases, application window 900 may also include additional options for the videoconference, such as the ability to transfer videoconference communications back to workstation 302 or desk phone 301. After the videoconference initializes on mobile phone 303 using the illustrated settings, the user can select or de-select options 901-904 at will during the remainder of the videoconference.

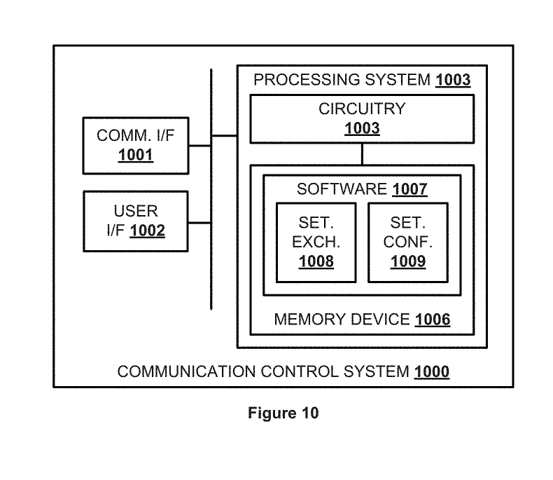

FIG. 10 illustrates a computing architecture for communication control system 1000. Communication control system 1000 is an example of communication control systems 104 and 307, although systems 104 and 307 may use alternative configurations. Communication control system 1000 comprises communication interface 1001, user interface 1002, and processing system 1003. Processing system 1003 is linked to communication interface 1001 and user interface 1002. Processing system 1003 includes processing circuitry 1005 and memory device 1006 that stores operating software 1007.

Communication interface 1001 comprises components that communicate over communication links, such as network cards, ports, RF transceivers, processing circuitry and software, or some other communication devices. Communication interface 1001 may be configured to communicate over metallic, wireless, or optical links. Communication interface 1001 may be configured to use TDM, IP, Ethernet, optical networking, wireless protocols, communication signaling, or some other communication format—including combinations thereof.

User interface 1002 comprises components that interact with a user. User interface 1002 may include a keyboard, display screen, mouse, touch pad, or some other user input/output apparatus. User interface 1002 may be omitted in some examples.

Processing circuitry 1005 comprises microprocessor and other circuitry that retrieves and executes operating software 1007 from memory device 1006. Memory device 1006 comprises a non-transitory storage medium, such as a disk drive, flash drive, data storage circuitry, or some other memory apparatus. Operating software 1007 comprises computer programs, firmware, or some other form of machine-readable processing instructions. Operating software 1007 includes communications exchange module 1008 and settings configuration module 1009. Operating software 1007 may further include an operating system, utilities, drivers, network interfaces, applications, or some other type of software. When executed by circuitry 1005, operating software 1007 directs processing system 1003 to operate communication control system 1000 as described herein.

In particular, communications exchange module 1008 directs processing system 1003 to facilitate a communication exchange by a first user system having a first feature set for a communication session using first settings of features in the first feature set. Settings configuration module 1009 directs processing system 1003 to determine a current state of the first settings before a second user system having a second feature set joins the communication session and configure second settings of the second feature set that correspond to the first settings in accordance with the current state. Communications exchange module 1008 further directs processing system 1003 to facilitate a communication exchange by the second user system for the communication session using the second settings of the second feature set.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for maintaining feature settings across user systems, the method comprising:
in a first user system having a first feature set, exchanging communications for a communication session using first settings of features in the first feature set;
determining a current state of the first settings before a second user system having a second feature set joins the communication session;
configuring second settings of the second feature set that correspond to the first settings in accordance with the current state;
in the second user system, exchanging communications for the communication session using the second settings of the second feature set.

2. The method of claim 1, further comprising:
receiving first user input from a first user of the first user system indicating that the communication session should be extended to the second user system; and
transferring the communication session from the first user system to the second user system in response to the first user input.

3. The method of claim 2, further comprising:
determining the current state and configuring the second settings in response to the first user input.

4. The method of claim 1, wherein configuring the second settings comprises:
when one or more of the second settings do not have a corresponding setting in the first settings, configuring the one or more of the second settings in accordance with one or more default settings.

5. The method of claim 1, further comprising:
presenting a first user of the first user system with an option to configure the second settings in accordance with the current state of the first settings.

6. The method of claim 5, further comprising:
receiving first user input from the first user indicating selection of the option; and
configuring the second settings in response to the first user input.

7. The method of claim 1, further comprising:
presenting the first user with an option to modify the current state of the first settings before configuring the second settings.

8. The method of claim 7, further comprising:
receiving first user input from the first user indicating one or more modifications to the current state of the first settings; and
further configuring the second settings in accordance with the one or more modifications.

9. The method of claim 1, wherein:
a current state of an audio mute setting within the first settings indicates that audio captured by the first user system is muted in the communication session; and
configuring the second settings comprises configuring an audio mute setting within the second settings to mute audio captured by the second user system in the communication session.

10. The method of claim 1, wherein:
a current state of a video mute setting within the first settings indicates that video captured by the first user system is muted in the communication session; and
configuring the second settings comprises configuring a video mute setting within the second settings to mute video captured by the second user system in the communication session.

11. A communication control system for maintaining feature settings across user systems, the communication control system comprising:
one or more computer readable storage media;
a processing system operatively coupled with the one or more computer readable storage media; and
program instructions stored on the one or more computer readable storage media that, when read and executed by the processing system, direct the processing system to:
facilitate a communication exchange by a first user system having a first feature set for a communication session using first settings of features in the first feature set;
determine a current state of the first settings before a second user system having a second feature set joins the communication session;
configure second settings of the second feature set that correspond to the first settings in accordance with the current state;
facilitate a communication exchange by the second user system for the communication session using the second settings of the second feature set.

12. The communication control system of claim 11, wherein the program instructions further direct the processing system to:
receive a notification from the first user system indicating that the communication session should be extended to the second user system, wherein the notification is transferred in response to first user input from a first user of the first user system; and
transferring the communication session from the first user system to the second user system in response to the first user input.

13. The communication control system of claim 12, wherein the program instructions further direct the processing system to:
determine the current state and configure the second settings in response to the notification.

14. The communication control system of claim 11, wherein the program instructions that direct the processing system to configure the second settings comprise program instructions that direct the processing system to:
when one or more of the second settings do not have a corresponding setting in the first settings, configure the one or more of the second settings in accordance with one or more default settings.

15. The communication control system of claim 11, wherein the program instructions further direct the processing system to:
provide the first user system with an option to configure the second settings in accordance with the current state of the first settings, wherein the first user system presents a first user of the first user system with the option.

16. The communication control system of claim 15, wherein the program instructions further direct the processing system to:
receive a notification from the first user system indicating selection of the option by the first user, wherein the notification is transferred in response to first user input from the first user; and
configure the second settings in response to the notification.

17. The communication control system of claim 11, wherein the program instructions further direct the processing system to:
provide the first user system with an option to modify the current state of the first settings before configuring the second settings, wherein the first user system presents the first user with the option.

18. The communication control system of claim 17, wherein the program instructions further direct the processing system to:
receive a notification from the first user system that first user input from the first user has been received indicating one or more modifications to the current state of the first settings; and
further configure the second settings in accordance with the one or more modifications.

19. The communication control system of claim 11, wherein:
a current state of an audio mute setting within the first settings indicates that audio captured by the first user system is muted in the communication session; and
the program instructions that direct the processing system to configure the second settings comprise program instructions that direct the processing system to configure an audio mute setting within the second settings to mute audio captured by the second user system in the communication session.

20. The communication control system of claim 11, wherein:
a current state of a video mute setting within the first settings indicates that video captured by the first user system is muted in the communication session; and
the program instructions that direct the processing system to configure the second settings comprise program instructions that direct the processing system to configure a video mute setting within the second settings to mute video captured by the second user system in the communication session.
